(19) United States
(12) Patent Application Publication
(10) Pub. No.: US 2016/0063073 A1
(43) Pub. Date: Mar. 3, 2016

(54) ELECTRONIC DEVICE AND METHOD FOR SEARCHING FOR APPLICATION

(71) Applicants: Fu Tai Hua Industry (Shenzhen) Co., Ltd., Shenzhen (CN); HON HAI PRECISION INDUSTRY CO., LTD., New Taipei (TW)

(72) Inventors: LING-JUAN JIANG, Shenzhen (CN); CHIH-SAN CHIANG, New Taipei (TW); HUA-DONG CHENG, Shenzhen (CN)

(21) Appl. No.: 14/697,113

(22) Filed: Apr. 27, 2015

(30) Foreign Application Priority Data
Sep. 3, 2014 (CN) 201410444509.5

(51) Int. Cl. G06F 17/30; G06F 3/0481

(52) U.S. Cl. CPC G06F 17/30554; G06F 3/0481

(57) ABSTRACT

An application search method includes obtaining functional descriptions of applications and generating functional features of the applications according to the obtained functional descriptions. Each of the generated function features is marked with at least one keyword associated with the functions of the applications and a relationship sheet is established between the applications and the keywords associated with the application. A request having input functional information for searching applications is received in response to input operations. Applications marching with the retrieve information are searched and displayed.

### CROSS-REFERENCE TO RELATED APPLICATIONS

This application claims priority to Chinese patent application No. 201410444509.5 filed on Sep. 3, 2014, the contents of which are incorporated by reference herein.

### FIELD

The subject matter herein generally relates to application management technology, and more particularly, to an electronic device and a method for searching for an application.

### BACKGROUND

With the development of the computer technology, there are a number of applications installed and run in electronic devices. In general, when using an application to finish a task, the user needs to open the application and select a function of the application.

### BRIEF DESCRIPTION OF THE DRAWINGS

Implementations of the present technology will now be described, by way of example only, with reference to the attached figures, wherein:

FIG. 1 is a block diagram of an embodiment of a hardware environment for executing an application search system.

FIG. 2 is a block diagram of an embodiment of function modules of the application search system in FIG. 1.

FIG. 3 is a flowchart of an embodiment of a method for searching application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The word “module,” and “unit” as used hereinafter, refers to logic embodied in hardware or firmware, or to a collection of software instructions, written in a programming language, such as, for example, Java, C, or assembly. One or more software instructions in the modules may be embedded in firmware, such as in an erasable programmable read only memory (EPROM). It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

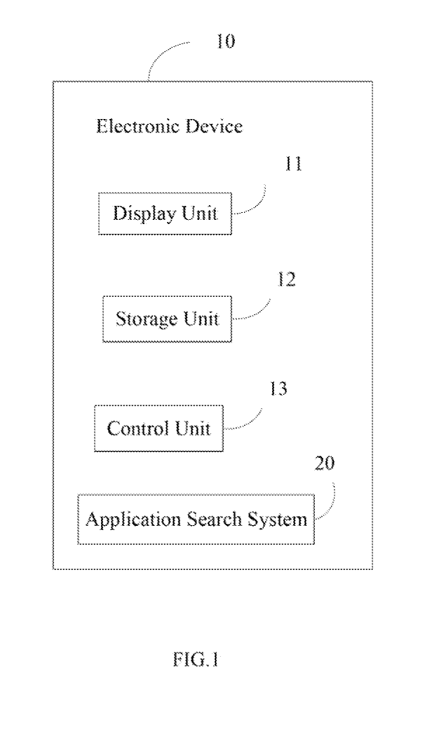

FIG. 1 is a block diagram of one embodiment of a hardware environment for executing an application search system 20. The application search system 20 is installed and run in an apparatus, for example an electronic device 10. The electronic device 10 includes, but is not limited to, a display unit 11, a storage unit 12, and a control unit 13.

In at least one embodiment, the storage unit 12 can be an internal storage device, such as a flash memory, a random access memory (RAM) for temporary storage of information, and/or a read-only memory (ROM) for permanent storage of information. The storage unit 12 can also be an external storage device, such as an external hard disk, a storage card, or a data storage medium. The storage unit 11 stores computerized codes of the function modules of the application search system 10. The control unit 13 can be a central processing unit (CPU), a microprocessor, or other data processor chip that performs functions of the electronic device 10.

The storage unit 12 stores a number of applications installed on the electronic device 10. Each of the applications is provided with at least one function to help users to perform activities. The storage unit 12 further stores information of the applications. In at least one embodiment, the information of an application includes functional description of the application, specification of the application, and source codes of the application. In the embodiment, the functional descriptions of the applications are included in the source codes of the applications. In an alternative embodiment, the functional descriptions of the application are included in the specifications of the applications.

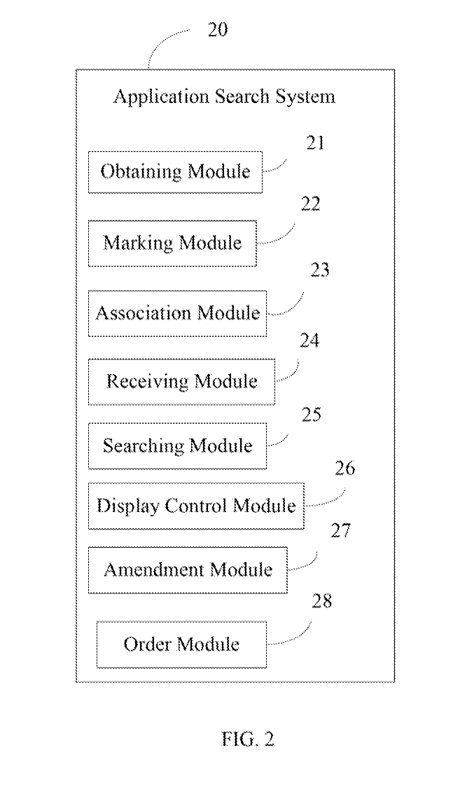

FIG. 2 shows a block diagram of an embodiment of function modules of the application search system (hereinafter “system”). The system 20 includes, but is not limited to, an obtaining module 21, a marking module 22, an association module 23, a receiving module 24, a searching module 25, and a display control module 26.

The obtaining module 21 can obtain functional descriptions of the applications and generate functional features of the applications according to the obtained functional description. In the embodiment, the obtaining module 21 obtains functional descriptions of the applications from the specifications of the applications. In an alternative embodiment, the obtaining module 21 obtains functional descriptions of the applications from the source codes of the applications.

The marking module 22 can mark each of the functional features with at least one keyword associated with the functions of the applications. In an alternative embodiment, the system 20 further includes an amendment module 27. The amendment module 27 can amend the keywords that are used to mark the functional features in response to input operations of a user. The keywords input by the users can be synonyms of the keywords generated by the marking module 22, general names or abbreviations of the functional features.

The association module 23 can establish a relationship sheet between the applications and the keywords associated with functions of the applications. The association module 23 further stores the established relationship sheet in a storage device, such as, in the storage unit 12 of the electronic device 10.

The receiving module 24 can receive requests for searching applications in response to input operations. The requests include input functional information which the users use to search the applications.

The searching module 25 can search the applications matching the request. In the embodiment, the searching module 25 compares the input function information with the keywords in the relationship sheet to determine the applications matching the applications searched by the users. In an alternative embodiment, the searching module 25 segments the input functional information into words and compares the words with the keywords in the relationship sheet to determine the applications matching the applications searched by the user.

In another embodiment, the system 20 further includes an order module 28. When the searching module 25 searches a number of applications matching the input function information, the order module 28 arranges the applications according to a predefined order, such as, according to degrees of matching between the input function information and the keywords in the relationship sheet.

The display control module 26 can display the searched applications in the display unit 11 of the electronic device 10. In an alternative embodiment, the display control module 26 can display the searched applications according to arranged order.

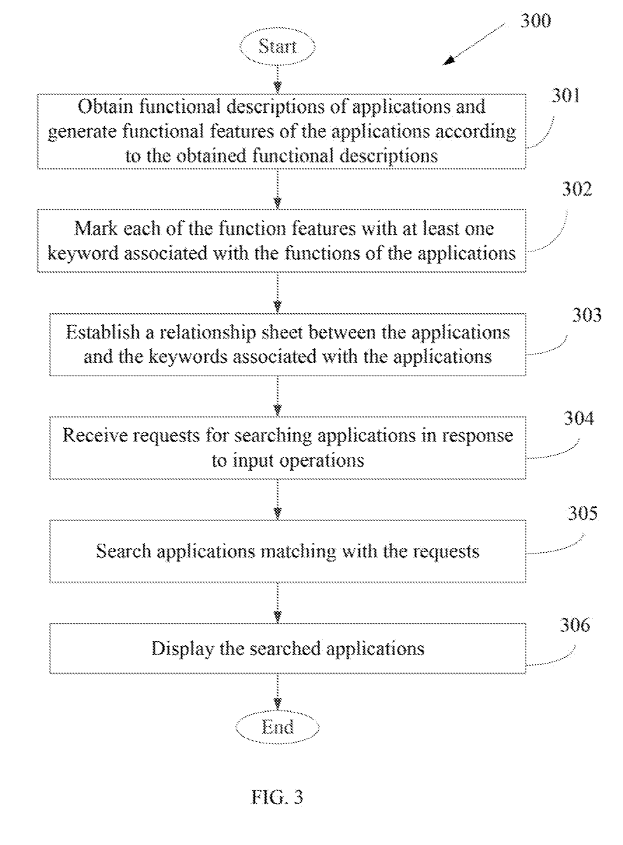

FIG. 3 illustrates a flowchart of an embodiment of a method for searching applications. In an example embodiment, the method is performed by execution of computer-readable software program codes or instructions by the control unit 13 of the electronic device 10. The method 300 is provided by way of example, as there are a variety of ways to carry out the method. The method 300 described below can be carried out using the configurations illustrated in FIGS. 1-2. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks can be utilized without departing from this disclosure. The example method 300 can begin at block 301.

At block 301, the obtaining module obtains functional descriptions of applications and generates functional features of the applications according to the obtained functional description. In the embodiment, the obtaining module obtains functional descriptions of the applications from the specifications of the applications. In an alternative embodiment, the obtaining module obtains functional descriptions of the applications from the source codes of the applications.

At block 302, the marking module marks each of the generated functional features with at least one keyword associated with the functions of the applications. In an alternative embodiment, the block 302 further includes: the amendment module amends the keywords that are used to mark the functional features in response to input operations.

At block 303, the association module establishes a relationship sheet between the applications and the keywords associated with the applications, and stores the established relationship sheet in a storage device.

At block 304, the receiving module receives requests for searching applications in response to input operations. The requests include input functional information of applications searched by the user.

At block 305, the searching module searches applications matching the request.

In at least one embodiment, the searching module compares the input functional information with the keywords in the relationship sheet to determine the applications matching the applications searched by the user. In an alternative embodiment, the searching module segments the input functional information into words and compares the words with the keywords in the relationship sheet to determine the applications matching the applications in the search. In the embodiment, when a number of applications match the input functional information, the order module arranges the applications according to a degree of matching between the input functional information and the keywords.

At block 306, the display control module displays the searched applications in the display unit of the electronic device. In an alternative embodiment, the display control module 26 can display the searched applications according to arranged order.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An application search method executable by at least one control unit of an electronic device, the method comprising:
obtaining functional descriptions of applications;
generating functional features of the applications according to the obtained functional descriptions;
marking each of the generated function features with at least one keyword, the at least one keyword associated with the functions of the applications;
establishing a relationship sheet between the applications and their associated keywords;
receiving requests having input-functional information in response to input operations;
searching for applications which correspond with the functional information;
receiving the searched for applications; and
displaying the searched for applications.

2. The method as claimed in claim 1, wherein the functional descriptions of the applications is obtained from source codes of the applications.

3. The method as claimed in claim 2, wherein the step “searching applications marching the input functional information” comprising: “comparing the input functional information with the keywords in the relationship sheet to determine the applications matching the input functional information”.

4. The method as claimed in claim 2, wherein the step “searching applications marching with the retrieve information” comprises: “segmenting the retrieve information into words and compares the segmented words with the keywords in the relationship sheet to determine the applications matching the input functional information”.

5. The method as claimed in claim 2, further comprising:
arranging the searched applications according to degrees of matching between the input functional information and the keywords; and
displaying the searched applications according to arranged order.

6. The method as claimed in claim 1, wherein the functional descriptions of the applications is obtained from specifications of the applications.

7. The method as claimed in claim 1, further comprising:
amending the keywords that are used to mark the functional features of applications in response to input operations.

8. An electronic device comprising:
a display unit;
a control unit; and
a storage unit storing one or more programs which, when executed by the control unit, causes the control unit to:
obtain functional descriptions of applications;
generate functional features of the applications according to the obtained functional descriptions;
mark each of the generated function features with at least one keyword, the at least one keyword associated with the functions of the applications;
establish a relationship sheet between the applications and their associated keywords;
receive requests having input functional information in response to input operations;
search for applications which correspond with the input functional information of applications users search;
receiving the searched for applications; and
display the searched for applications.

9. The electronic device as claimed in claim 8, wherein the functional descriptions of the applications is obtained from source codes of the applications.

10. The electronic device as claimed in claim 9, wherein “searching applications marching the input functional information” comprises “comparing the input functional information with the keywords in the relationship sheet to determine the applications searched by the user”.

11. The electronic device as claimed in claim 9, wherein “searching applications marching with the retrieve information” comprises “segmenting the retrieve information into words and compares the segmented words with the keywords in the relationship sheet to determine the applications searched by the user”.

12. The electronic device as claimed in claim 12, further comprising:
arranging the searched applications according to degrees of matching between the input functional information and the keywords; and
displaying the searched applications according to arranged order.

13. The electronic device as claimed in claim 13, further comprising amending the keywords that are used to mark the functional features of applications in response to input operation.

14. The electronic device as claimed in claim 8, wherein the functional descriptions of the applications is obtained from specifications of the applications.

15. A non-transitory storage medium having stored thereon instructions that, when executed by a processor of an electronic device, causes the processor to perform a management method, wherein the method comprises:
obtaining functional descriptions of applications;
generating functional features of the applications according to the obtained functional descriptions;
marking each of the generated function features with at least one keyword, the at least one keyword associated with the functions of the applications;
establishing a relationship sheet between the applications and their associated keywords;
receiving requests having input-functional information in response to input operations;
searching for applications which correspond with the functional information;
receiving the searched for applications; and
displaying the searched for applications.

16. The non-transitory storage medium as claimed in claim 15, wherein the step “searching applications marching the input functional information” comprising: comparing the input functional information with the keywords in the relationship sheet to determine the applications matching the input functional information”.

17. The non-transitory storage medium as claimed in claim 15, wherein the step “searching applications marching with the retrieve information” comprises: “segmenting the retrieve information into words and compares the segmented words with the keywords in the relationship sheet to determine the applications matching the input functional information”.

18. The non-transitory storage medium as claimed in claim 15, further comprising:
arranging the searched applications according to degrees of matching between the input functional information and the keywords, and
displaying the searched applications according to arranged order.

19. The non-transitory storage medium as claimed in claim 15, further comprising:
amending the keywords that are used to mark the functional features of applications in response to input operations.
